(19) United States
(12) Patent Application Publication
(10) Pub. No.: US 2002/0011303 A1
(43) Pub. Date: Jan. 31, 2002

(54) Decorative article and process and preform for producing decorative articles

(76) Inventor: Karen Eastman, W. Bloomfield, MI (US)

Correspondence Address: John R. Benefiel, Suite 100 B, 280 Daines Street, Birmingham, MI, 48009, US

(21) Appl. No.: 09/906,564

(22) Filed: Jul. 16, 2001

Related U.S. Application Data
(60) Provisional application No. 60/218,885, filed on Jul. 18, 2000.

(51) Int. Cl. B29C 47/00

(52) U.S. Cl. 156/246

(57) ABSTRACT

A decorative article is produced by creating a preform comprised of a solidified puddled mass of resin from a molten stream of resin discharged down onto a collecting surface. The preform is trimmed, reheated to be smoothed and selectively reshaped, and providing with a mounting to create a decorative article. The purge discharged from an injection molding machine is utilized to create a preform to recover the cost of the purged resin otherwise discarded or recycled.

### CROSS REFERENCE TO RELATED APPLICATIONS

This application claims the benefit of U.S. provisional Ser. No. 60/218,885, filed on Jul. 18, 2000.

### BACKGROUND OF THE INVENTION

This invention concerns decorative articles comprised of three dimensional abstract shapes or fanciful figures to be displayed.

Decorative articles of this type are typically sculpted from such materials as wood, stone, plaster, cast metal, or welded together pieces of metal, etc. Blown glass is also used to form such decorative articles.

Such articles require considerable effort to produce. Further, the resultant articles have an undesirable similarity to each other.

It is the object of the present invention to provide an abstract or fanciful figure shaped decorative article and a process for producing the same which provides a unique look of each individual pieces, and involves the use of a preform which allows a quicker and easier completion of such decorative articles even through having a largely unique appearance.

There has been a longstanding effort to utilize a high strength resin such as polycarbonate for automotive glazing panels, which appears close to becoming a commercial reality. The huge production volumes in involved in the automotive industry would create a considerable volume of purged resin.

It is a further object of the present invention to create a use for such purge resin so as to reduce the amount of material waste and the recycling efforts required.

### SUMMARY OF THE INVENTION

The above recited object, as well as other objects which will become apparent upon a reading of the following specification and claims are achieved by injecting plastic resin from a port from some distance above a surface to allow a randomly shaped mass of plastic to form when the resin hardens.

The resinous mass is then cleaned, and sharp appendages removed as by cutting them away.

The resinous mass may be reheated for reshaping to modify the appearance as desired.

The finished article may be mounted on a base and/or hook for wall mounting. The preforms can be combined using pin connections to create a composite article.

So called “purge regrind” may be salvaged to enhance the value of the resin normally simply sold at low prices for recycling. That is, the hardened masses of purged resin cleaned, suitably reworked, and adapted for table top or wall mounting. This provides a use for purge material which creates economic return recycling and obviate the need for recycling.

This has particular application to injection molding of clear or tinted polycarbonate of the type used for automotive glazing, as polycarbonate is strong and durable to allow the creation of decorative articles able to withstand incidental handling despite having thin portions which are not unduly fragile. The transparency of this material also results in particularly attractive decorative articles, and the varying thicknesses of portions of the articles creates a varying transparency trending to opaqueness, adding to the visual appeal of the articles.

### DESCRIPTION OF THE DRAWINGS

FIG. 1 is a diagram of the process of creating a preform according to the present invention.

FIG. 2 is a perspective view of a first decorative article crafted using the preform and process according to the present invention.

FIG. 3 is a perspective view of a second decorative article crafted using the preform and process according to the present invention.

FIG. 4 is a perspective view of a third decorative article crafted using the preform and process according to the present invention.

FIG. 5 is a perspective view of a fourth decorative article crafted using the preform and process according to the present invention.

FIG. 6 is a perspective view of a fifth decorative article crafted using the preform and process according to the present invention.

FIG. 7 is a perspective view of a sixth decorative article crafted using the preform and process according to the present invention.

FIG. 8 is a perspective view of a seventh decorative article crafted using the preform and process according to the present invention.

FIG. 9 is a perspective view of a eighth decorative article crafted using the preform and process according to the present invention.

FIG. 10 is a perspective view of a ninth decorative article crafted using the preform and process according to the present invention.

FIG. 11 is a perspective view of a tenth decorative article crafted using the preform and process according to the present invention.

FIG. 12 is a perspective view of a eleventh decorative article crafted using the preform and process according to the present invention.

### DETAILED DESCRIPTION

In the following detailed description, certain specific terminology will be employed for the sake of clarity and a particular embodiment described in accordance with the requirements of 35 USC 112, but it is to be understood that the same is not intended to be limiting and should not be so construed inasmuch as the invention is capable of taking many forms and variations within the scope of the appended claims.

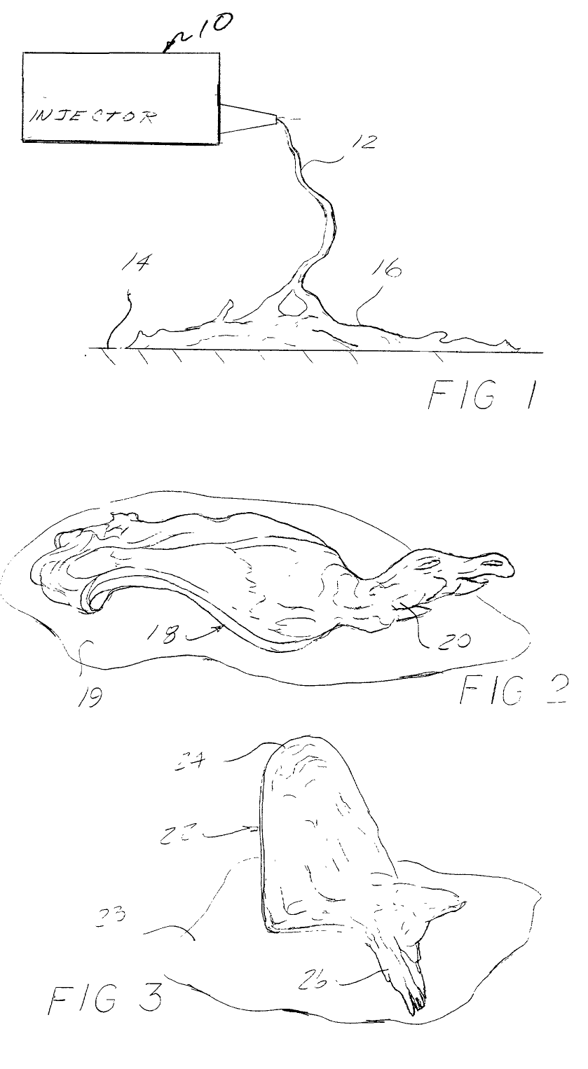

Referring to the drawings, FIG. 1 depicts diagrammatically a source 10 of molten resin under pressure, such as a standard commercial injection molding machine, from which a stream 12 of molten resin such as polycarbonate is issuing, collecting on a surface 14 disposed beneath the source 12.

An injection machine normally has a purge port from which there is a discharge of plastic during a purge cycle required to clear the internal chambers when shutting down or changing over resins. According to one aspect of the invention, such purged resin is utilized as a preform for constructing a decorative article to gain value from the material and avoid the need to regrinding to recycle the material or to dispose of the same in a landfill.

Alternatively, a preform can also be made by injecting resin from the injection port of the machine rather than reclaiming purged material. Similarly, a heated reservoir which has an injection port from which molten resin is controllably discharged by the pressure of compressed air (not shown) as a low cost alternative to a commercial injection machine.

The resin stream issues for a distance of several feet about the surface such that long appendages may form on the mass of resin after cooling. The main quantity of resin collects in a puddle, with randomly generated contours which will typically be unique for each injection cycle.

Preferably, a polycarbonate resin is used, clear or tinted as this has been found to be sufficiently hard when cooled to be durable and yields visually interesting masses of cooled resin suitable preforms for forming a decorative article. However, other resins such as acrylics, etc. maybe used.

The volume of the resin charge ejected may also be varied to produce an article of a certain size range of article. The resin may be clear, tinted, colored, or contains visually appealing granules.

In many instances, the thin streams often fold back and forth and sink into the collecting mass, creating a whorled surface texture.

After cooling, the hardened resinous mass 16 is collected and cleaned of any adhering impurities.

The appearance of the resinous mass 16 is appraised for potential decorative looks.

Unwanted appendages formed by hardened resin streams may be pruned with a suitable tool. The mass 16 can also be carved using a portable grinding/cutting tool such as a Dremel® tool.

A heat gun may be used to heat certain areas to smooth the same, as by rubbing with gloves.

Appendages can be heated in this way to be bent, reshaped, etc.

Reheating the whole resinous mass 16 allows bending of the main parts of the resinous mass 16 as desired to create a desired appearance.

The collection surface 14 can be flat (or contoured) and at ambient temperatures, and textured, heated or cooled to produce a variety of characteristic shaping of the result preform.

The finished article can be mounted on a base or support for a table top display or provided with a hook for a wall display. If the article is stable in the displayed position, the base may be dispensed with.

FIGS. 2-12 depict variously shaped decorative articles which are representative of the diverse appearance that the articles may take.

In FIG. 2, a puddled shaped article 18 is shown having a broad “tail” 20 which has been bent upwardly. The article 18 is adapted to be displayed by being rested on a horizontal surface 19.

In FIG. 3, an article 22 has a forward portion 24 bent up and a rear “feathered” portion 26 bent down, again this article 22 able to rest stably on a horizontal surface 23.

In FIG. 4, the article 28 suggesting a bird-like shape is supported on edge in an upright portion by a base 30 gripping a lower portion.

An appendage 32 has been bent over the main mass. The surface 34 is textured by whorls of the stream sinking into the main mass, which is translucent.

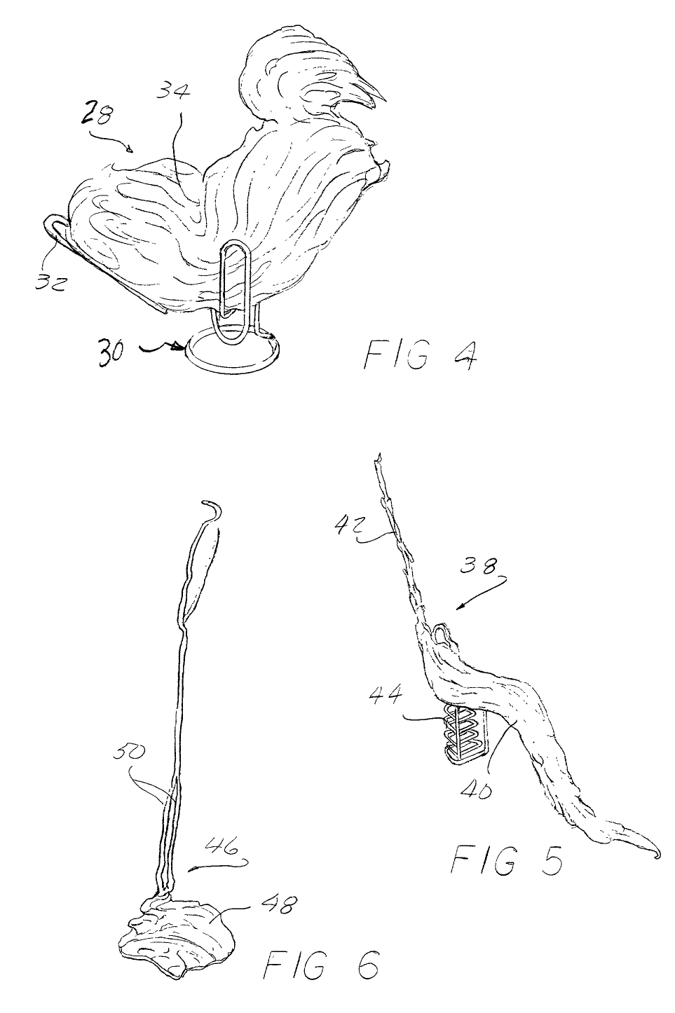

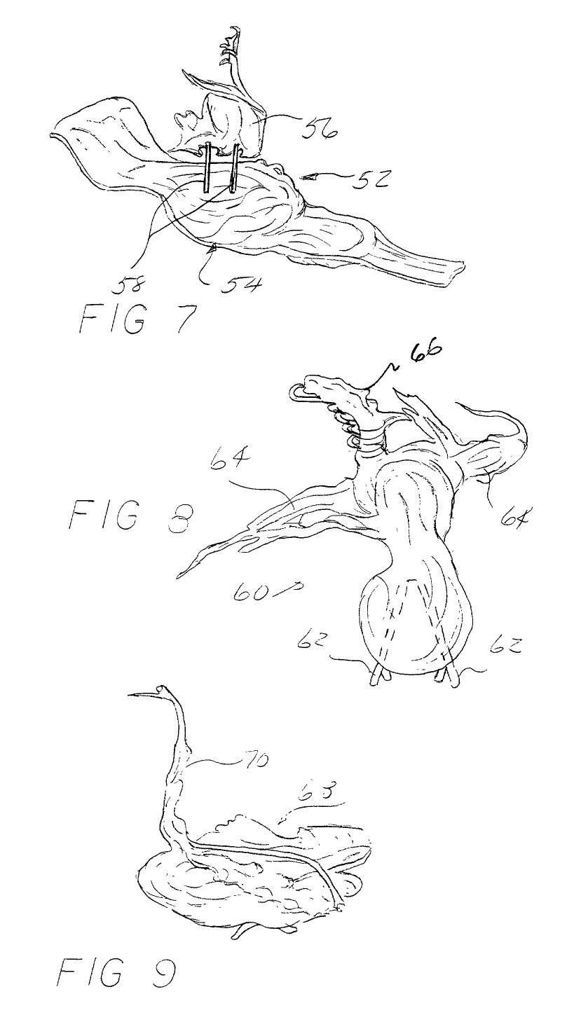

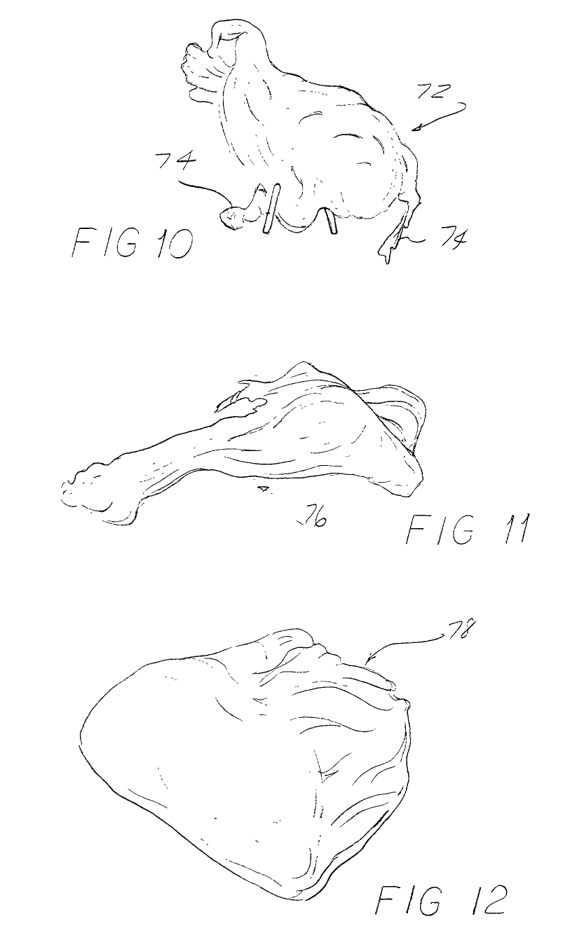

FIG. 5 shows an article 38 formed from a hardened narrow stream 40 and an appendage 47.

The puddle stream portion 40 has been bent to form a curved step and the appendage angled up sharply. A base 44 provides a support.

In FIG. 6, an article 46 is formed from a more rounded puddle portion 48 has thin vertical appendages 50 projecting therefrom.

FIG. 7 shows a composite article 52 formed by a lower mass 54 having an upper piece 56 connected thereto by pins 58.

FIG. 8 shows an article 60 support upright on a base leg 62., with wing-like appendages 64 and head-like appendage 66.

FIG. 9 shows a swan-like article 68 having a curved upright appendage 70.

FIG. 10 shows an article 72 having downwardly extending appendages 74, suggesting a legged animal.

FIG. 11 shows a more massive article 76 suggesting a wave shape.

FIG. 12 shows a smaller sized article 78 with a dished shape.

The discharge of purged charges of resin onto a surface where a resin stream collects in a puddle mass has been found to be useful for providing preforms to be reworked into decorative articles, which use solves the problem associated with recycling or discarding of this material as has been done in the past.

This reworking has been found to create highly aesthetic decorative articles which may be sold at attractive prices, creating a market value to obviate the need for recycling or discard of waste material in landfills.

1. A process for utilizing purged resin discharged from an injection molding machine comprising the steps of:
discharging said purged resin through a port located spaced above a collecting surface so that streams of discharged resin collect in a puddled mass on said surface;
allowing cooling and solidification of said discharged resin;
preparing said solidified resinous mass for use as a decorative article; and
selling said decorative article.

2. The method according to claim 1 wherein said preparing step includes the step of mounting said solidified mass on a holder.

3. The method according to claim 1 wherein said preparing step includes the step of trimming projecting appendages from said solidified mass.

4. The method according to claim 1 wherein said step includes the step of reheating at least a portion of said solidified resinous mass and reshaping said reheated portion.

5. The method according to claim 1 wherein said step includes the step of connecting together two or more of said solidified resinous masses to create a decorative article.

6. The method according to claim 1 wherein said re sin is polycarbonate.

7. A method of providing a preform for making a decorative article comprising the step of ejecting a molten stream of resin and allowing the same to descend down onto a collecting surface to form a puddled mass of said resin; and
allowing said puddled resinous mass to solidify to form said preform.

8. A method of constructing a decorative article comprising the steps of:
forcing a stream of molten resin down onto a collecting surface to form a puddled resinous mass;
allowing cooling of said molten resin to solidify into a preform having one or more appendages formed by a solidified streams of resin; and
preparing a decorative article from said preform.

9. The method according to claim 8 wherein said preparing step includes the steps of reheating and reshaping portions of said preform.

10. The method according to claim 8 wherein said preparing step includes the steps of reheating and smoothing the surface of said preform.

11. The method according to claim 8 wherein said preparing step includes the step of installing a mount to said decorative article.

12. The method according to claim 8 wherein a molten clear polycarbonate resin is forced out in a stream down onto a collecting surface.

13. The decorative article formed by the method of claim 8.

14. The decorative article formed by the method of claim 9

15. The decorative article formed by the method of claim 10.

16. The decorative article formed by the method of claim 11

17. The decorative article formed by the method of claim 12.
